(19) United States
(12) Patent Application Publication
(10) Pub. No.: US 2006/0145590 A1
(43) Pub. Date: Jul. 6, 2006

(54) Funnel for use in a cathode ray tube

(75) Inventors: In Hee Ahn, Kyungki-do (KR); Jung Mook Kim, Kyungki-do (KR)

Correspondence Address: BACON & THOMAS, PLLC, 625 SLATERS LANE, FOURTH FLOOR, ALEXANDRIA, VA, 22314, US

(73) Assignee: Samsung Corning Co., Ltd., Kyungki-do (KR)

(21) Appl. No.: 11/200,123

(22) Filed: Aug. 10, 2005

(30) Foreign Application Priority Data
Dec. 31, 2004 (KR) 10-2004-0118095
Jul. 13, 2005 (KR) 10-2005-0063313

(51) Int. Cl. H01J 29/86; H01J 61/30

(52) U.S. Cl. 313/477 R; 220/2.1 A; 220/2.1 R

(57) ABSTRACT

A funnel for use in a cathode ray tube having a panel includes a body portion having a seal edge to be connected to the panel and having a major axis of two longer sides of the body portion, a minor axis of two shorter sides of the body portion and diagonal axes; a yoke portion extending backward from the body portion; and an inflection portion formed on at least one portion of an inner surface of the body portion at a predetermined distance from the seal edge. The inflection portion is formed such that a thickness of the seal edge is less than that of the body portion.

### FIELD OF THE INVENTION

The present invention relates to a funnel for use in a cathode ray tube; and, more particularly, to a funnel for use in a cathode ray tube which is capable of achieving a weight reduction and slimming down of the cathode ray tube without changing a pin radius and a mold match line outside diameter.

### BACKGROUND OF THE INVENTION

A glass bulb employed in a cathode ray tube for use in manufacturing a color television, a computer monitor, and the like basically includes three main parts, i.e., a panel for displaying images thereon, a conical funnel connected to a backside of the panel and a cylindrical neck connected to the apex portion of the funnel. The panel, the funnel and the neck are formed of glass, and particularly the panel and the funnel are fabricated by press forming a lump of molten glass called a glass gob into desired sizes and shapes.

A general configuration of a conventional cathode ray tube is illustrated in FIGS. 1 and 2. A panel 20 of a glass bulb 10 includes a face portion 21 for displaying images thereon; a skirt portion 23 extending backward from the periphery of the face portion 21 and having a seal edge 22; and a blend radius portion 24 for joining the face portion 21 with the skirt portion 23. Further, the panel 20 is of a substantially rectangular shape with a major axis 27 of two longer sides 26a and 26b, a minor axis 28 of two shorter sides 25a and 25b, and diagonal axes 29.

A funnel 30 includes a body portion 32 having a seal edge 31 and a yoke portion 33 extending backward from the body portion 32, wherein the seal edge 31 of the body portion 32 is connected to the seal edge 22 of the panel 20, thus forming a panel junction 11. Further, the yoke portion 33 has a seal edge 34 on its back end, which is connected to a seal edge 41 of a neck 40, thus forming a neck junction 12.

Further, a shadow mask 50 having a plurality of holes (not shown) is supported at the skirt portion 23 of the panel 20 by stud pins 51. Installed at the neck 40 is an electron gun 60 for emitting electron beams to an image-forming fluorescent material coated on an inner surface of the face portion 21 through the holes of the shadow mask 50. Also, a deflection yoke 70 for deflecting the electron beams emitted from the electron gun 60 is installed at the yoke portion 33 of the funnel 30.

Recently, various attempts have been made to reduce the total depth of the cathode ray tube as well as to enlarge and flatten its screen portion. However, if the funnel 30 is manufactured in such a manner that the deflection angle can be increased up to at least 120 degrees to slim down the cathode ray tube, this may raise a problem concerning the mechanical strength of the glass bulb 10 that is required to satisfy an IEC (International Electrotechnical Commission) 16965 standard for implosion resistance for the safety of users.

In order to avoid such structural weakness of the cathode ray tube, the thickness of each of the panel 20 and the funnel 30 may be increased. However, this solution leads to an increase in the amount of the glass gob used, which in turn results in raising the manufacturing costs and the weight of the glass bulb 10. Furthermore, defects such as cracks and the like may be caused on the seal edge 34 because the flow rate of the glass gob increases at a time of press-forming the funnel 30.

Moreover, if the thickness of the panel 20 is increased, pin radii of the stud pins 51, i.e., the distances from the center of the panel 20 to the inner ends of the stud pins 51 in the directions of the major axis 27 and the minor axis 28 should be changed as well. In addition, the size of the shadow mask 50 should also be changed based on the changes in the pin radii. In addition, it is necessary to perform a job changing process for resetting various equipments including a stud pin sealing machine, a shadow mask welder, and so forth. So a great amount of time and costs are required for the plant and equipment investment. Meanwhile, in case of increasing mold match line outside diameters (MMODs) in the directions of the major axis 27, the minor axis 28 and the diagonal axis 29 to maintain the pin radii, a cabinet or an outer casing in which the cathode ray tube is installed fitting the mold match line outside diameter therein should be newly fabricated, so that a great amount of time and coasts are needed for the plant and equipment investment.

### SUMMARY OF THE INVENTION

It is, therefore, a primary object of the present invention to provide a funnel for use in a cathode ray tube, which is capable of achieving a weight reduction and slimming down of the cathode ray tube without changing a pin radius and a mold match line outside diameter, while satisfying an IEC (International Electrotechnical Commission) 16965 standard for implosion resistance by improving a mechanical strength of a glass bulb.

It is another object of the present invention to provide a slim funnel for use in a cathode ray tube which has a deflection angle equal to or greater than 120 degrees, and which is capable of reducing the thickness of a panel junction while maintaining a sufficient mechanical strength of a glass bulb.

It is still another object of the present invention to provide a funnel for use in a cathode ray tube, which is capable of preventing defects such as a crack during a press-forming process, and which requires no resetting process for equipments, to thereby improve productivity and reduce manufacturing costs.

In accordance with a preferred embodiment of the present invention, there is provided a funnel for use in a cathode ray tube having a panel, including: a body portion having a seal edge to be connected to the panel and having a major axis of two longer sides of the body portion, a minor axis of two shorter sides of the body portion and diagonal axes; a yoke portion extending backward from the body portion; and an inflection portion formed on at least one portion of an inner surface of the body portion at a predetermined distance from the seal edge, wherein the inflection portion is formed such that a thickness of the seal edge is less than that of the body portion.

In accordance with another preferred embodiment of the present invention, there is provided a funnel for use in a cathode ray tube having a panel, including: a body portion having a seal edge to be connected to the panel and having a major axis of two longer sides of the body portion, a minor axis of two shorter sides of the body portion and diagonal axes; a yoke portion extending backward from the body portion; and a stepped portion formed on at least one portion of an inner surface of the body portion at a predetermined distance from the seal edge, wherein the stepped portion is formed in such a manner that a thickness of the seal edge is less than that of the body portion.

### BRIEF DESCRIPTION OF THE DRAWINGS

The above and other objects and features of the present invention will become apparent from the following description of preferred embodiments given in conjunction with the accompanying drawings, in which:

FIG. 1 is a cross sectional view of a conventional cathode ray tube;

FIG. 2 sets forth a front view of a panel for use in the conventional cathode ray tube;

FIG. 3 presents a cross sectional view of a cathode ray tube including a funnel in accordance with a preferred embodiment of the present invention;

FIG. 4 shows a partial cross sectional view of a panel of the cathode ray tube including the funnel in accordance with the preferred embodiment of the present invention, wherein the panel is cut along the direction of a major axis;

FIG. 5 illustrates a partial cross sectional view of a panel of the cathode ray tube including the funnel in accordance with the present invention, wherein the panel is cut along the direction of a minor axis;

FIG. 6 is a partial cross sectional view of the funnel in accordance with the preferred embodiment of the present invention, wherein the funnel is cut along the direction of the major axis;

FIG. 7 offers a partial cross sectional view of the funnel in accordance with the preferred embodiment of the present invention, wherein the funnel is cut along the direction of the minor axis; and

FIG. 8 depicts a front view of the funnel in accordance with the preferred embodiment of the present invention.

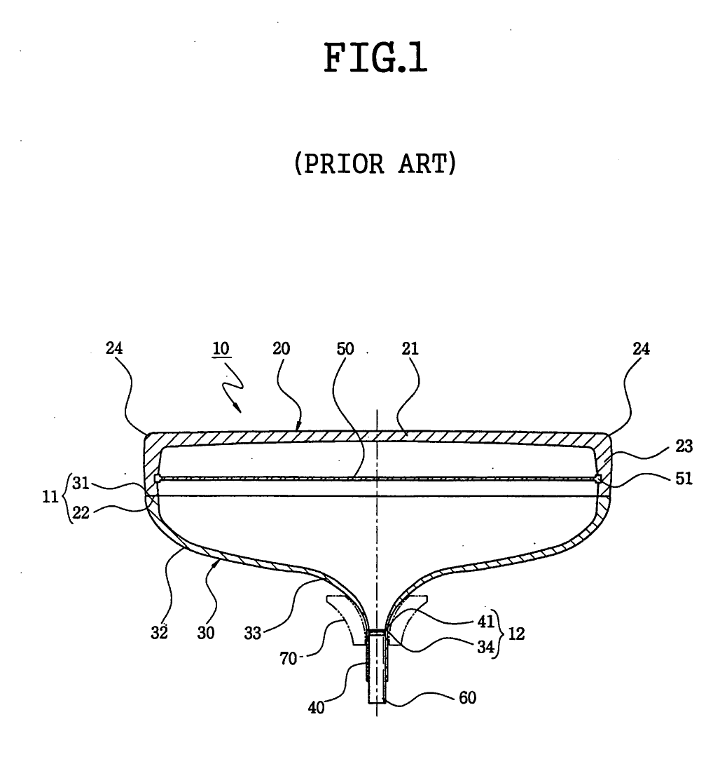

### DETAILED DESCRIPTION OF THE PREFERRED EMBODIMENTS

Hereinafter, a funnel for use in a cathode ray tube in accordance with a preferred embodiment of the present invention will be described in detail with reference to the accompanying drawings.

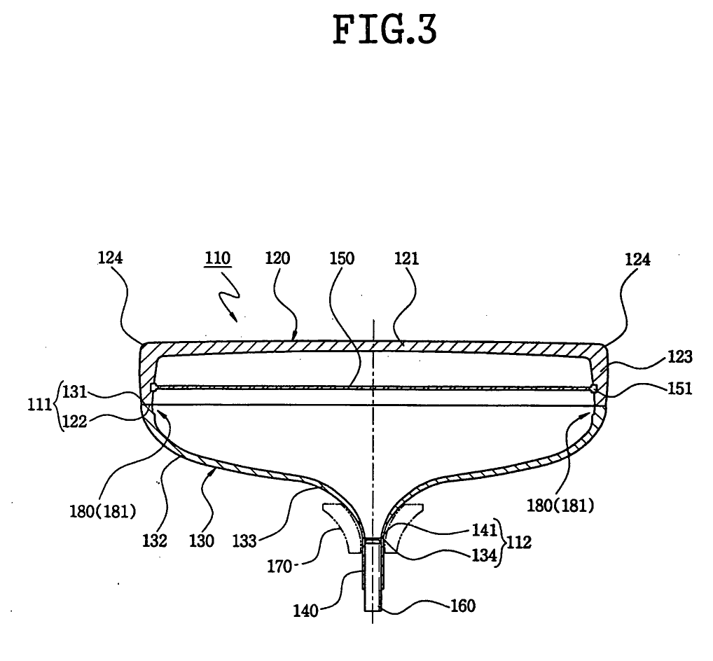

Referring to FIGS. 3 to 5, a panel 120 of a glass bulb 110 includes a face portion 121 for displaying images thereon; a skirt portion 123 extending backward from the periphery of the face portion 121 and having a seal edge 122; and a blend radius portion 124 for joining the face portion 121 with the skirt portion 123. A shadow mask 150 with a number of holes (not shown) is supported at the skirt portion 123 of the panel 120 via a plurality of stud pins 151.

Referring to FIGS. 3 and 6 to 8, a funnel 130 in accordance with the preferred embodiment of the present invention is designed to be of a slim type with a deflection angle not smaller than 120 degrees. The funnel 130 includes a body portion 132 with a seal edge 131 and a yoke portion 133 extending backward from the body portion 132. The seal edge 131 of the funnel 130 is connected to the seal edge 122 of the panel 120, thus forming a panel junction 111 of the glass bulb 110. The yoke portion 133 has a seal edge 134 on its back end, which is connected to a seal edge 141 of a neck 140 forming a neck junction 112 of the glass bulb 110. Installed at the neck 140 is an electron gun 160 for emitting electron beams to an image-forming fluorescent material coated on an inner surface of the face portion 121 through the holes of the shadow mask 150. Further, a deflection yoke 170 for deflecting the electron beams emitted from the electron gun 160 is installed at the yoke portion 133 of the funnel 130.

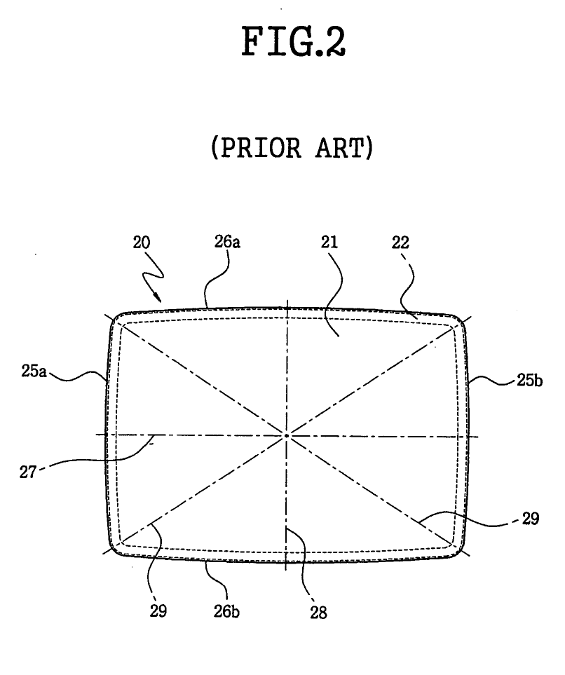

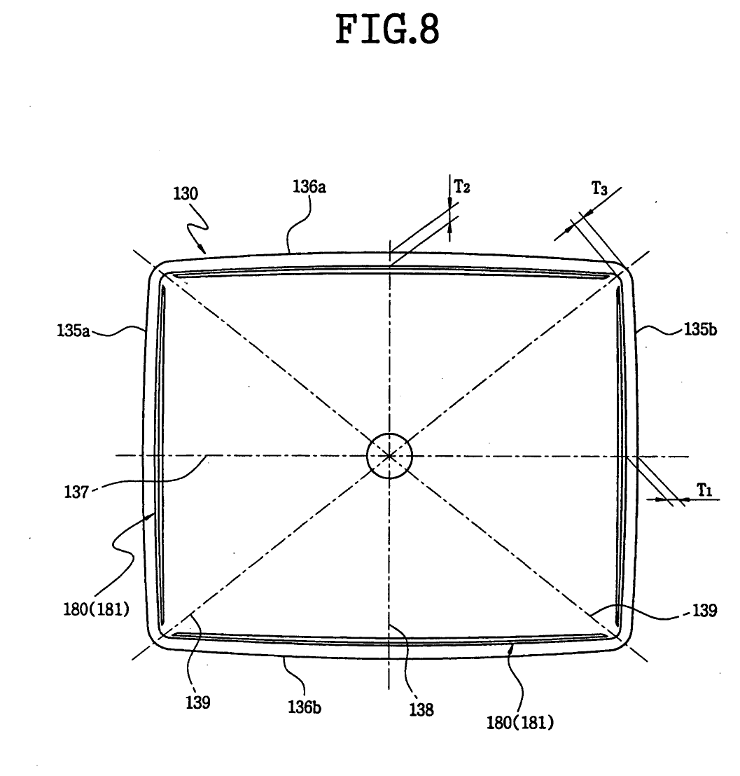

As shown in FIG. 8, when viewed from front, the funnel 130 is of an approximately rectangular shape with a major axis 137 of longer sides 136a and 136b, a minor axis 138 of shorter sides 135a and 135b, and diagonal axes 139, alike the panel 10 shown in FIG. 2.

Referring to FIGS. 3, 6 to 8, the funnel 130 for use in a cathode ray tube in accordance with the preferred embodiment of the present invention is formed in such a manner that thicknesses T₁ and T₂ of the seal edge 131 along the directions of the major axis 137 and the minor axis 138, respectively are less than thicknesses T₄ and T₅ of the body portion 132 along the directions of the major axis 137 and the minor axis 138, respectively. Further, an inflection portion 180 is formed on an inner surface of the body portion 132 spaced apart from the seal edge 131 of the funnel 130 by a predetermined distance to connect the inner surface of an end portion containing the seal edge 131 with the inner surface of the body portion 132 behind the end portion. In accordance with the preferred embodiment of the present invention, the inflection portion 180 can be formed with a moderate slope by using at least one curve and/or at least one straight line.

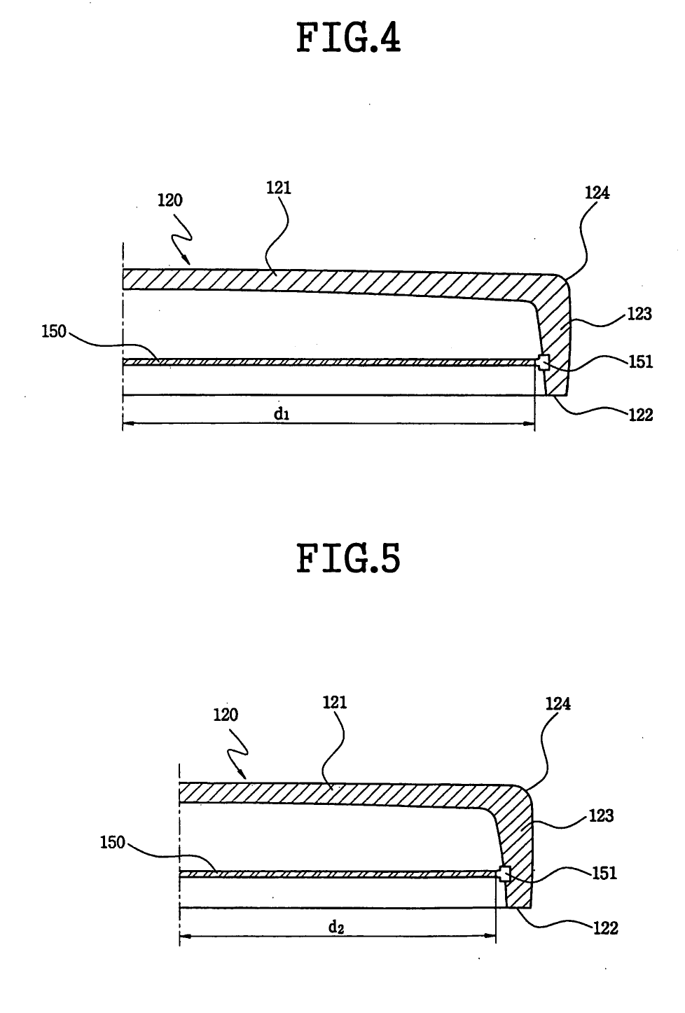

Meanwhile, the reference notation d1 shown in FIG. 4 represents a pin radius (mm) indicating a distance from the center of the panel 120 to the inner end of the stud pin 151 installed at the skirt portion 123 along the direction of the major axis 137, while the reference notation d2 in FIG. 5 represents a pin radius (mm) indicating a distance from the center of the panel 120 to the inner end of the stud pin 151 installed at the skirt portion 123 along the direction of the minor axis 138.

Preferably, the inflection portion 180 is formed on the inner surface of the body portion 132 spaced apart from the seal edge 131 by about 1.2 to 40 mm. The inner and the outer end portion of the seal edge 131 are provided with bevels (not shown) which form a sealing pool for a weld penetration of crystalline glass powder called frits for use in bonding the panel 120 and the funnel 130 to each other. Each bevel is formed from the seal edge to a position apart therefrom by about 0.6 to 1.0 mm. If the inflection portion 180 is formed at a position spaced apart from the seal edge 131 by less than 1.2 mm, it may affect the formation of the bevels. If the inflection portion 180 is formed at a position spaced apart from the seal edge 131 by more than 40 mm, it may cause a reduction in the mechanical strength of the glass bulb 110.

Referring to FIGS. 3, 7 and 8, the inflection portion 180 can be replaced by a stepped portion 181 which is protrudingly formed on the inner surface of the body portion 132 spaced apart from the seal edge 131 by about 1.2 to 25.0 mm, and which protrudes from the inner end portion of the seal edge 131 by about 0.4 to 7.0 mm. If the stepped portion 181 is formed at a position spaced apart from the seal edge 131 by less than 1.2 mm, it may affect the formation of the bevels. If the stepped portion 181 is formed at a position spaced apart from the seal edge 131 by more than 25.0 mm, on the other hand, it may result in a reduction in the mechanical strength of the glass bulb 110. Further, if the stepped portion 181 protrudes from the inner end portion of the seal edge 131 by less than 0.4 mm, an operator for inspection cannot examine the stepped portion 181 with the naked eye. If the stepped portion 181 is formed to protrude from the inner end portion of the seal edge 131 by more than 7.0 mm, on the other hand, the amount of glass gob used may increase considerably.

In FIG. 8, the inflection portions 180 or the stepped portions 181 are formed on the inner surfaces of the body portion 132 along the directions of the major axis 137 and the minor axis 138 while they are not formed at four corner parts of the body portion 132 where diagonal axes 139 cross. Further, it should be noted that the inflection portion 180 or the stepped portion 181 can be formed on the inner surface of the body portion 132 in at least one of the directions of the major axis 137, the minor axis 138 and the diagonal axes 139.

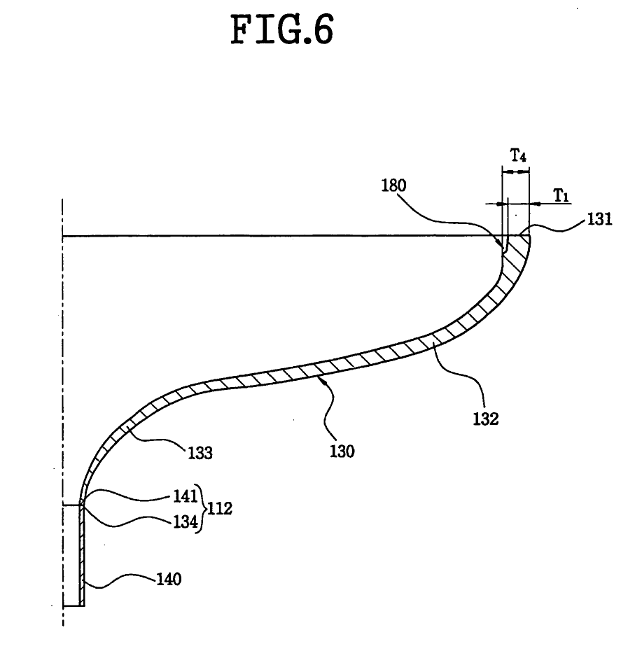

Referring to FIG. 6, the thickness T₁ of the seal edge 131 along the direction of the major axis 137 is set to maintain a thickness difference of at least 0.8 mm from the thickness T₄ of the body portion 132 in the direction of the major axis 137, thus satisfying Eq. 1 as follows.
T₄−T₁≧0.8 mm Eq. 1

If the thickness T₁ of the seal edge 131 along the direction of the major axis 137 does not satisfy the relationship in Eq. 1, the pin radius d1 of the stud pin 151 installed at the skirt portion 123 in the direction of the major axis 137 should be changed.

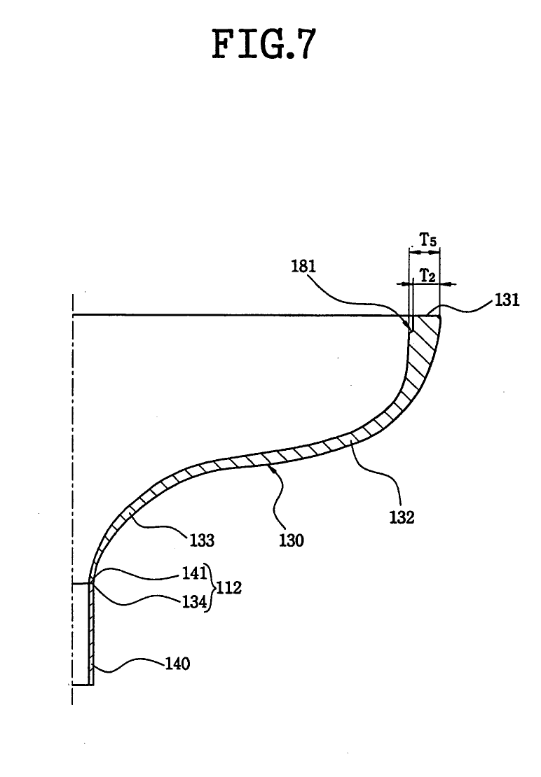

As shown in FIG. 7, the thickness T₂ of the seal edge 131 in the direction of the minor axis 138 is set to maintain a thickness difference of at least 1.0 mm from the thickness T₅ of the body portion 132 in the direction of the minor axis 138, thus satisfying Eq. 2 as follows.
T₅−T₂≧1.0 mm Eq. 2

If the thickness T₂ of the seal edge 131 along the direction of the minor axis 138 does not satisfy the relationship in Eq. 2, the pin radius d2 of the stud pin 151 installed at the skirt portion 123 along the direction of the minor axis 138 should be changed.

### EXPERIMENTAL EXAMPLES

Weights (kg), stresses (MPa), incidence rates (%) of a seal edge crack, pin radii (mm) and mold match line outside diameters (mm) of funnels 130, each being formed to have the seal edge 131 with a thickness less than the thickness of the body portion 132, were measured, and the results are provided in Table 1. The kind of machine to which funnels in accordance with Example 1 and Comparative Examples 1 and 2 are employed is a 29-inch cathode ray tube, while the kind of machine to which funnels in accordance with Example 2 and Comparative Examples 3 and 4 is a 34-inch cathode ray tube.

In Table 1, the stresses (MPa) at a lower end portion of the seal edge 131 (hereinafter, simply referred to as seal edge lower end stress) were measured at a point spaced apart from the seal edge 131 by about 30 mm. Further, the pin radii (mm) in Table 1 represent a set of the pin radius d2 of the stud pin 151 installed at the skirt portion 123 along the direction of the minor axis 138, as shown in FIG. 5, and the pin radius d1 of the stud pin 151 installed at the skirt portion 123 along the direction of the major axis 137, as shown in FIG. 4. In addition, the mold match line outside diameters (mm) refer to a set of distances along the directions of the minor axis 138, the major axis 137 and the diagonal axis 139.

TABLE 1

| | | | | | Stress (MPa) | | | | |
|---|---|---|---|---|---|---|---|---|---|
| | | | | | | Seal | | | |
| | Kind of | Seal Edge | Weight | | | Edge | Incidence | Pin | |
| Ex. | machine | Thickness | (Kg) | | Seal | Lower | Rate | Radius | MMOD |
| No. | (inch) | (mm) | Panel | Funnel | Edge | End | (%) | (mm) | (mm) |
| Ex. 1 | 29 | 13.5 × 12.5 × 12.5 | 19.4 | 10.4 | 9.3 | 9.4 | 0.3 | 215.5 × 280.1 | 472.7 × 600.8 × 724.0 |
| Ex. 2 | 34 | 16.0 × 14.0 × 14.0 | 31.1 | 15.4 | 9.9 | 9.8 | 0.5 | 256.3 × 330.5 | 564.8 × 712.4 × 857.6 |
| Comparative | 29 | 15.5 × 14.0 × 13.0 | 20.0 | 10.5 | 8.8 | 9.5 | 1.2 | 215.5 × 280.1 | 476.7 × 604.8 × 724.0 |
| Ex. 1 | | | | | | | | | |
| Comparative | 29 | 15.5 × 14.0 × 13.0 | 19.9 | 10.5 | 8.9 | 9.3 | 1.2 | 213.5 × 278.1 | 472.7 × 600.8 × 724.0 |
| Ex. 2 | | | | | | | | | |
| Comparative | 34 | 17.5 × 16.0 × 14.5 | 32.0 | 15.6 | 9.4 | 10.0 | 1.4 | 256.3 × 330.5 | 571.8 × 719.4 × 857.6 |
| Ex. 3 | | | | | | | | | |
| Comparative | 34 | 17.5 × 16.0 × 14.5 | 31.8 | 15.6 | 9.5 | 9.8 | 1.4 | 252.8 × 327.0 | 564.8 × 712.4 × 857.6 |
| Ex. 4 | | | | | | | | | |

As can be seen from Table 1, the seal edge thicknesses along the directions of the major axis, the minor axis and the diagonal axis in Example 1 are less than the seal edge thicknesses along the directions of the major axis, the minor axis and the diagonal axis in Comparative Examples 1 and 2. Further, the weight of the funnel of Example 1 is less than the weights of the funnels of Comparative Examples 1 and 2 by 0.1 kg, while the weight of a panel in Example 1 is less than the weight of panels of Comparative Examples 1 and 2 by 0.6 and 0.5 kg. Accordingly, by using the funnel of Example 1, a slim cathode ray tube with a reduced weight can be fabricated, and manufacturing costs can be reduced due to a reduction in the amount of glass gob used.

Moreover, the seal edge stress of Example 1 is greater than those of Comparative Examples 1 and 2 by 0.5 and 0.4 MPa, while the seal edge lower end stress of Example 1 is almost identical to those of Comparative Examples 1 and 2. The maximum value of a seal edge stress and a seal edge lower end stress capable of satisfying an IEC standard for implosion resistance is 10.0 MPa, and thus safe cathode ray tubes that satisfy the IEC standard for implosion resistance can be fabricated by using the funnels of Example 1 and Comparative Examples 1 and 2 because their seal edge stresses and seal edge lower end stresses are less than 10.0 MPa. However, when performing a press-forming process, the incidence rate of a seal edge crack of Example 1 was revealed to be less than those of Comparative Examples 1 and 2 by 0.9%. As a consequence, badness of the funnel of Example 1 can be reduced, so that productivity can be improved and manufacturing costs can be reduced.

Meanwhile, the pin radius (mm) 215.5×280.1 and the mold match line outside diameter (mm) 472.7×600.8×724.0 in Example 1 are standard values for a cathode ray tube. Referring to Table 1, the pin radius (mm) of Comparative Example 1 is equal to the standard value of Example 1, but the mold match line outside diameter (mm) of Comparative Example 1 is changed considerably. Further, the mold match line outside diameter of Comparative Example 2 is equal to the standard value of Example 1, its pin radius (mm) is changed considerably. Accordingly, the funnel 30 in accordance with the preferred embodiment of the present invention does not cause any job changing process for resetting equipments including a stud pin sealing machine, a shadow mask welder, and so forth, so that productivity can be improved and manufacturing costs can be reduced.

Further, the seal edge thicknesses in directions of the major axis, the minor axis and the diagonal axis in Example 2 are less than the seal edge thicknesses along directions of the major axis, the minor axis and the diagonal axis in Comparative Examples 3 and 4. Further, the weight of the funnel of Example 2 is less than the weights of the funnels in Comparative Examples 3 and 4 by 0.2 kg, while the weight of a panel of Example 2 is less than the weights of panels of Comparative Examples 3 and 4 by 0.9 and 0.7 kg. Accordingly, by using the funnel of Example 2, a slim cathode ray tube with a reduced weight can be fabricated, and manufacturing costs can be reduced due to a smaller amount of glass gob used.

In addition, the seal edge stress of Example 2 is greater than those of Comparative Examples 3 and 4 by 0.5 and 0.4 MPa, while the seal edge lower end stress of Example 2 is almost identical to those of Comparative Examples 3 and 4. Since the seal edge stresses and the seal edge lower end stresses of Example 2 and Comparative Examples 3 and 4 are less than 10.0 MPa, fabrication of safe cathode ray tubes capable of satisfying the IEC standard for implosion resistance can be accomplished by using the funnels of Example 2 and Comparative Examples 3 and 4. However, when performing the press-forming process, the incidence rate of a seal edge crack of Example 2 was revealed to be less than those of Comparative Examples 3 and 4 by 0.9%. As a consequence, badness of the funnel of Example 2 can be reduced, so that productivity can be improved and manufacturing costs can be reduced.

Meanwhile, the pin radius (mm) 256.3×330.5 and the mold match line outside diameter (mm) 564.8×712.4×857.6 in Example 2 are standard values for a cathode ray tube. Referring to Table 1, the pin radius (mm) of Comparative Example 3 is equal to the standard value of Example 2, but the mold match line outside diameter (mm) of Comparative Example 3 is changed considerably. Further, the mold match line outside diameter of Comparative Example 4 is identical to the standard value of Example 2, but its pin radius (mm) is changed considerably. Accordingly, the funnel 30 in accordance with the preferred embodiment of the present invention does not cause any job changing process for resetting equipments including a stud pin sealing machine, a shadow mask welder, and so forth, so that productivity can be improved and manufacturing costs can be reduced.

In accordance with the preferred embodiment of the present invention described above, a funnel for a cathode ray tube is configured to have an inflection portion or a stepped portion on a body portion's inner surface spaced apart from a seal edge at a predetermined distance, so that the seal edge has a thickness less than a thickness of the body portion. With this configuration, the cathode ray tube can be slimmed down with a reduced weight while satisfying the IEC standard for implosion resistance by enhancing the mechanical strength of a glass bulb without changing a pin radius and a mold match line outside diameter. In particular, in case of a slim funnel having a deflection angle of at least 120 degrees, the thickness of a panel junction can be reduced, while maintaining a sufficient mechanical strength of the glass bulb. Also, a defect caused by an occurrence of a crack, or the like during a press-forming process can be reduced, and a resetting of equipments is unnecessary. Accordingly, productivity can be improved and manufacturing costs can be reduced.

While the invention has been shown and descried with respect to the preferred embodiments, it will be understood by those skilled in the art that various changes and modifications may be made without departing from the spirit and scope of the invention as defined in the following claims.

What is claimed is:

1. A funnel for use in a cathode ray tube having a panel, comprising:
a body portion having a seal edge to be connected to the panel and having a major axis of two longer sides of the body portion, a minor axis of two shorter sides of the body portion and diagonal axes;
a yoke portion extending backward from the body portion; and
an inflection portion formed on at least one portion of an inner surface of the body portion at a predetermined distance from the seal edge,
wherein the inflection portion is formed such that a thickness of the seal edge is less than that of the body portion.

2. The funnel of claim 1, wherein the thickness T₁ (mm) of the seal edge and the thickness T₄ (mm) of the body portion along a direction of the major axis satisfy a relationship of T₄−T₁≧0.8 mm, or the thickness T₂ (mm) of the seal edge and the thickness T₅ (mm) of the body portion along a direction of the minor axis satisfy a relationship of T₅−T₂≧1.0 mm.

3. The funnel of claim 1, wherein the inflection portion, which is formed on the inner surface of the body portion, is at a distance of approximately 1.2 to 4 mm from the seal edge.

4. The funnel of claim 2, wherein the inflection portion, which is formed on the inner surface of the body portion, is at a distance of approximately 1.2 to 4 mm from the seal edge.

5. The funnel of claim 1, wherein the inflection portion is formed on the inner surface of the body portion along at least one of directions of the major axis, the minor axis and the diagonal axes.

6. The funnel of claim 2, wherein the inflection portion is formed on the inner surface of the body portion along at least one of directions of the major axis, the minor axis and the diagonal axes.

7. A funnel for use in a cathode ray tube having a panel, comprising:
a body portion having a seal edge to be connected to the panel and having a major axis of two longer sides of the body portion, a minor axis of two shorter sides of the body portion and diagonal axes;
a yoke portion extending backward from the body portion; and
a stepped portion formed on at least one portion of an inner surface of the body portion at a predetermined distance from the seal edge,
wherein the stepped portion is formed such that a thickness of the seal edge is less than that of the body portion.

8. The funnel of claim 7, wherein the stepped portion, which is formed on the inner surface of the body portion, is at a distance of approximately 1.2 to 25.0 mm from the seal edge and the stepped portion protrudes from an inner end portion of the seal edge by approximately 0.4 to 7.0 mm.

9. The funnel of claim 7, wherein the stepped portion is formed on the inner surface of the body portion along at least one of directions of the major axis, the minor axis and the diagonal axes.

10. The funnel of claim 8, wherein the stepped portion is formed on the inner surface of the body portion along at least one of directions of the major axis, the minor axis and the diagonal axes.
